(19) United States
(12) Patent Application Publication
(10) Pub. No.: US 2023/0341916 A1
(43) Pub. Date: Oct. 26, 2023

(54) PROVIDING LOCAL COMPUTING CAPACITY FOR AN EDGE CLOUD

(71) Applicant: SIEMENS AKTIENGESELLSCHAFT, München (DE)

(72) Inventors: Hans-Peter Huth, München (DE); Florian Zeiger, Höhenkirchen-Siegertsbrunn (DE); Markus Sauer, München (DE)

(21) Appl. No.: 17/927,871

(22) PCT Filed: May 6, 2021
(86) PCT No.: PCT/EP2021/061975

§ 371 Date: Nov. 25, 2022

(30) Foreign Application Priority Data
May 27, 2020 (EP) 20176883.5

(51) Int. Cl. G06F 1/28

(52) U.S. Cl. CPC G06F 1/28

(57) ABSTRACT

The invention relates to an automated method for providing local computing capacity for at least one local computing unit (1.1) for a less required computing task (3) of a demander, wherein the local computing unit (1.1) is used at least partially for controlling a local power generation unit (5.2), wherein the local computing unit (1.1) is provided as part of a local Edge Cloud (1), wherein the electrical energy generated by the local power generation unit (5.2) is used for supplying power to the Edge Cloud (1), and wherein the local computing capacity is provided to the demander by the Edge Cloud (1) in the event of an over-production of power. The invention also relates to an associated device for providing local computing capacity of at least one local computing unit (101) for a less required computing task (3) of a demander.

This application is the National Stage of International Application No. PCT/EP2021/061975, filed May 6, 2021, which claims the benefit of European Patent Application No. EP 20176883.5, filed May 27, 2020. The entire contents of these documents are hereby incorporated herein by reference.

### FIELD

The present embodiments relate to an automated method and a device for providing local computing capacity for at least one local computing unit for a less required computing task of a demander, where the local computing unit is used at least in part for controlling a local power generation unit.

### BACKGROUND

Plants for producing energy using solar cells or wind energy typically contain complex control electronics, as well as computing power and connectivity. Nowadays, such plants are isolated from their surroundings (e.g., access is possible only via a secure portal, and services or apparatuses that are unknown to the plants are unable to access them). The operator of the energy plant is responsible for availability and energy generation. Small plants, however, frequently belong to an operator that also operates other plants and apparatuses.

One example is an agricultural business that operates solar cells in addition to keeping livestock or cultivating food, often in very close physical proximity or even on the same land. These trades require communication and IT services too, which nowadays are to be provided completely independently of the energy infrastructure.

At present, the IT infrastructure necessary for operation is used exclusively for operating the plants. Since very high requirements regarding availability and security are to be met here, however, IT resources that still have computing capacities free are ultimately available here.

Nowadays, when operating decentralized power generation plants with renewable energies, there is the problem of energy being generated at times when it is not possible to supply this energy to the power grid or to store the energy.

WO 2019/141587 A1 describes a method and a system for providing local computing capacity for a local computing unit for a less required computing task of a demander.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a solution for effectively using locally generated electrical energy and computing capacity is provided.

One aspect of the present embodiments consists in using the excess, locally generated electrical energy locally in order to allow a locally available IT infrastructure to perform computing tasks. This may be done by the operator itself, but the operator may also make this IT infrastructure available to a larger, potentially decentralized IT market place.

This kind of use of the energy infrastructure as an edge cloud and local communication platform for other purposes is not possible with known products since, for IT security reasons and network management reasons, the hosting of extraneous services is not possible or requires a very high level of complexity, and therefore is not economical.

The present embodiments thus describe a method for how the electrical energy may be efficiently used locally by using industrial edge cloud technologies, and in this case, the energy is not brought to the task, but rather a computing task to be accomplished is brought to the available energy. This may, by way of example, pursue two different aims: 1. to use locally excess energy at times of energy overproduction (e.g., power excess) in a useful way, as compared to dissipating energy in order to keep the energy grid stable; and 2. to provide local computing power in the dynamic edge cloud only at times of local power overproduction, which was not easily achievable with known solutions on account of communication limitation.

The term “edge cloud” is becoming increasingly important. In the context of the present application, “edge cloud” refers to a local, modular computer network. However, this term is not clearly defined. What the various descriptions relating to the local, modular computer network have in common is that this network is part of a computer network that is arranged close to the user. Certain services may be kept locally, and the local, modular computer network may provide better performance with regard to data processing. This local, modular computer network may provide limited access to sensors and actuators and be included in security concepts. A local, modular computer network is generally used industrially or commercially.

The patent application DE 10 2017 207 918 A1 describes an edge cloud of this kind for industrial applications.

The IT of a power generation unit at present typically consists of a plurality of industrial PCs and gateways to the external grids. The PCs are at present operated as stand-alone systems for controlling the energy plant. The required high availability is achieved here by redundancies and locally (e.g., within the energy plant) distributed computing units.

In order to implement the mechanism described in the present embodiments, the IT infrastructure available locally in the power generation unit is now configured as an edge cloud by using cloud technologies, such as, for example, Kubernetes, https://kubernetes.io. A multi-rental capability of the IT infrastructure is thus achieved in the first act. The control software specific to the plants and software that is unknown to the plants may thus a) be neatly separated from a security standpoint and b) be efficiently placed and controlled regarding the consumption of resources.

At the same time, the capability is created to dynamically provide functionality, such as, for example, in the form of containers or in a serverless manner in the form of functions. The network within the power generation unit is likewise security-critical and is to be protected. This happens via rules within the industrial PCs that control routing and bandwidths. This may be accomplished by solutions from the applicant, such as disclosed in the patent application WO 2018 206 502 A1.

In a further aspect, the edge cloud may be logically interconnected with another edge cloud. This is, for example, useful with another available edge cloud of the plant owner (e.g., the edge cloud for an agricultural plant). An application that is unknown to the business may thus be provided within the IT of the power generation unit that provides services, such as, for example, computing power, over the Internet.

In a further aspect, the logical interconnection of a plurality of edge clouds will occur dynamically depending on currently running applications such that permanent provision of the connection between the edge clouds and the applicable resources of the edge clouds is not required. At the same time, not all of the interconnected edge clouds have to be used by an application. Parallel operation of one or more applications on the edge cloud combination is achievable.

Advantages of the described solution include local conversion of energy into computer power and thus reduction in the communication demands compared to cloud-centric solutions. If energy cannot be transported in the event of a power overproduction because there are no power consumers, “refined data” are transported to a demander. Advantages also include: efficient use of energy that is generated but cannot be used, by using edge clouds—; provision of decentralized IoT/compute islands that reliably and efficiently form computation and communication environments—; sustainable and energy-efficient IT/edge cloud (e.g., losses during the transmission of energy are avoided; available energy from renewable sources may be used locally when (as is so often the case) there is no demand for energy supply in the power grid); decentralized infrastructure that reacts to environmental influences (e.g., available energy) dynamically and may be used as appropriate by providing its services dynamically; locally excess energy (e.g., power overproduction) is available dynamically, and the availability is possible conditionally in forecast periods of minutes/a few hours; the mechanism described may react thereto and deal therewith—; redundancy concepts and mechanisms for high availability may also be implemented through the interaction with further decentrally organized units that is present in the administrative component—; the mechanism also allows edge cloud islands to operate in areas with otherwise poor coverage (e.g., agriculture, offshore production, fishing, forestry, environmental protection) and allows continued operation in the event that the external communication infrastructures should fail.

An important aspect is the combination of a control grid of an energy generation plant/power generation unit with edge cloud concepts. An energy plant operator may thus do additional business by selling computing power and telecommunications. The operation of such an edge cloud will also afford ecological advantages since the operation is sustained close to the energy generation with minimal losses and may consume excess energy. Further, such integration allows largely self-sufficient islands to be set up; thus, modern IT solutions may also be offered in areas with poor communication links.

The present embodiments include an automated method for providing local computing capacity for at least one local computing unit for a less required computing task of a demander. The local computing unit is used at least in part for controlling a local power generation unit, where the local computing unit is provided as part of a local edge cloud. The electrical energy generated by the local power generation unit is used for supplying energy to the edge cloud. The local computing capacity is provided to the demander by the edge cloud only at times when excess electrical energy due to energy overproduction is available. Exclusively, the excess electrical energy is used for providing the local computing capacity.

As a result, excess computing capacity in the event of a local power overproduction may be offered, and the power produced does not have to be dissipated.

In one development, a business policy manager module formed in the edge cloud may determine, based on predefined rules, how much of and when the excess electrical energy may be used for executing the computing task.

In a further configuration, during the determination, the business policy manager module may take into account at least one external first parameter determined outside of the local power generation unit and at least one internal second parameter determined inside of the local power generation unit.

In a further configuration, the second parameter may be an amount of energy currently being generated by the local power generation unit and/or an amount of energy to be delivered.

In a further configuration, the first parameter may be present weather data, predictive weather data, data about planned works on the local power generation unit, and/or market prices for the electrical energy.

The edge cloud may optionally be offered as a load in the local energy market, and power may thus be taken from the energy grid.

The business manager module implements a “rules engine” that is used to execute rules set by the owner or operator of the plant via the strategy selector module.

In one development, a strategy selector module formed in the edge cloud may parameterize the business policy manager module and provide decision rules and decision priorities.

In one development, user-specific roles may be configured in the strategy selector module for parameterizing the business policy manager module.

In a further embodiment, the user-specific role may be an infrastructure owner, a customer, a trusted machine, or a trusted further edge cloud.

One example of a decision rule resulting from the parameterization may be that if energy that otherwise cannot be used further is available for longer than two hours, then the resources of the edge cloud are used for handling external tasks for at least three hours.

In a further embodiment, the edge cloud may be logically interconnected with at least one further edge cloud dynamically depending on currently running applications.

The present embodiments also include a device for providing local computing capacity for at least one local computing unit for a less required computing task of a demander. The local computing unit is configured at least in part for controlling a local power generation unit. The local computing unit is configured as part of a local edge cloud. The device is configured to use the electrical energy generated by the local power generation unit for supplying energy to the edge cloud. The edge cloud is configured to provide the local computing capacity to the demander only at times when excess electrical energy due to energy overproduction is available. Exclusively, the excess electrical energy is used for providing the local computing capacity.

In a further embodiment, the device has a business policy manager module formed in the edge cloud and configured to determine, based on predefined rules, how much of and when the excess electrical energy may be used for executing the computing task.

In a further embodiment, the business policy manager module may be configured to take into account at least one external first parameter determined outside of the local power generation unit and at least one internal second parameter determined inside of the local power generation unit during the determination.

In a further embodiment, the device may have a strategy selector module formed in the edge cloud and configured to parameterize the business policy manager module and provide decision rules and decision priorities.

Further special features and advantages of the invention will become apparent from the following explanations of exemplary embodiments with reference to schematic drawings.

### BRIEF DESCRIPTION OF THE DRAWINGS

FIG. 1 shows a block diagram of one embodiment of an edge cloud; and

FIG. 2 shows a block diagram of one embodiment of an application of the edge cloud to a scenario with an agricultural business.

### DETAILED DESCRIPTION

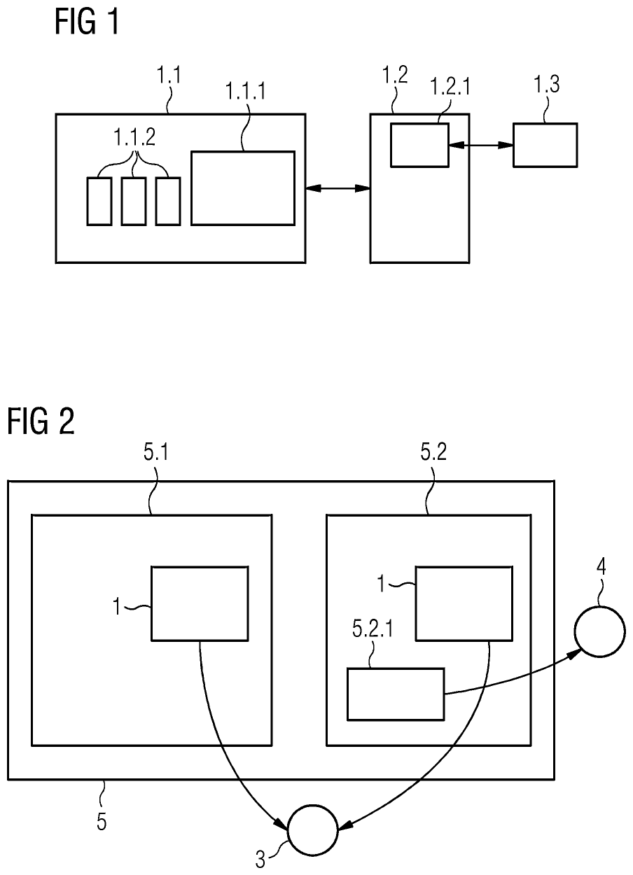

FIG. 1 shows a block diagram of one embodiment of an edge cloud 1. The edge cloud 1 with a plurality of components (e.g., one or more local computing units 1.1) may also be referred to as a computer node or edge server. The local computing unit 1.1 represents a local computing capacity of the edge cloud 1. This is used in order to host the edge cloud 1 via a host 1.1.1 and to make available various virtual private clouds 1.1.2 (VPCs) in order to thus allow the demander-specific and isolated processing of computing tasks.

An administration component that is used to select all of the local configuration settings of the edge cloud 1 is configured in the host 1.1.1. The administration component is executed locally on the host 1.1.1 and interacts with the “feature repository module,” the “edge cloud management and operation module,” and a plurality of further components.

A plurality of interfaces are also configured in the host 1.1.1: an administration interface used by the administration component to select settings and change configurations locally on the apparatus (e.g., computing unit 1.1) and the operating system thereof; a deployment interface used for distributing applications in the edge cloud environment; a configuration interface used for configuring the edge cloud components; a feature discovery interface that provides the administration component with an overview of the locally available capabilities and also allows the administration component to activate these capabilities; and a tasks and services interface used by the administration component to distribute tasks in the edge cloud 1.

The edge device management and operation module 1.2 (e.g., formed by one or more processors) is configured to be able to execute all of the mechanisms for operating and managing the edge cloud 1. A plurality of submodules are implemented in the edge device management and operation module 1.2. The plurality of submodules include a business policy manager module 1.2.1 that implements a “rules engine” that is used to execute rules set by the owner or operator of the local power generation unit 2 via a strategy selector module 1.3 (details thereon provided below). For this purpose, use is made of external first parameters, such as, for example, present weather data, weather forecast data, currently planned works on a business connected to the local power generation unit, and/or market prices for the energy generated, and internal second parameters, such as, for example, data about the present energy generation or energy factors, in order to decide, based on the rules, how much of and when the energy from a power overproduction should or may be used for a requested computing task and also how much of the energy should be supplied. The proposed edge cloud 1 may optionally be offered as a load in the local energy market, and power may thus be taken from the local energy grid. Local computing capacity is made available for computing tasks of demanders exclusively when there is a local power overproduction.

The plurality of submodules also include an edge cloud manager module that is responsible for facilitating the efficient and secure operation of the local edge cloud 1 in accordance with information from the business policy manager module 1.2.1, the capability manager module, the trust manager module, and the billing module. The edge cloud manager module may also coordinate with other local edge clouds and thus distribute or exchange tasks.

The plurality of submodules also include a capability manager module that makes certain capabilities available to individual edge cloud resources of the local edge cloud. These do not necessarily always have to be available, however. Such temporary availabilities, but also availabilities influenced by other basic conditions, are managed by the capability manager module. The results regarding availability that result from these, also external, basic conditions, are made available to the edge cloud manager module.

The plurality of submodules also include a trust manager module that makes available one or more identities of the respective edge cloud system. This may be accomplished via certificates, for example. These provide, for example, via signatures for transactions, that the latter are verifiable, and a trusted exchange takes place when accepting a task and providing result data.

The plurality of submodules also include a billing module that, based on the data provided by the edge cloud manager module regarding accepted and executed computing tasks in the edge cloud, provides the billing for the executed computing tasks with the applicable task requirements or with other edge clouds. This may happen fully automatically and optionally via “smart contracts” in a blockchain.

The feature repository module configured in the edge cloud stores all of the capabilities of the respective edge cloud modules and provides the capabilities, if needed, to the administration component. This includes the locally available capabilities, such as, for example, computing power, storage, support for AI/ML calculations, provision of wireless communication technologies or provision of an access point into the Internet, and optionally also capabilities of other, non-locally available resources, such as, for example, other nearby edge clouds or temporarily available resources.

The feature repository module may, for example, run locally on edge devices, may be reachable via remote access, or may be set up in a distributed manner. The local features module of the feature repository module contains all of the capabilities available in the local edge cloud. The optional external features module of the feature repository module contains capabilities of nearby resources that may likewise be used if needed.

The external factors & requirements module is configured to describe all of the external factors or parameters, such as, for example, availability of energy, local presence (e.g., in the case of mobile resources).

The strategy selector module 1.3 is configured to parameterize the business policy manager module 1.2.1. The strategy selector module 1.3 provides decision rules and decision priorities. The parameterization may be carried out, for example, by users with different roles, such as, for example, infrastructure owners, customers, trusted machines, and other trusted edge clouds. One example of a decision rule resulting from the parameterization may be, for example: if energy that otherwise cannot be used further is available for longer than two hours, then use the resources of the edge cloud for handling external computing tasks for at least three hours.

The above-described modules and submodules of the edge cloud 1 may implement the following processes: 1) Identifying and detecting the available capabilities; 2) Identifying rules and basic conditions that are necessary for providing the capabilities (e.g., energy)>plan, ad-hoc, hybrid, etc.; 3) Providing the available capabilities/services; 4) Accepting a job (e.g., passive waiting for computing tasks)/looking for a job (actively looking for computing tasks if resources are available to use); 5) Configuring and starting further services, such as, for example, local access point for radio communication; 6) Policy management/enabling rules/service level agreements; 7) Trust/billing (billing for chargeable services); 8) Coordinating with the energy-generating plant (strategy selector module 1.3, see above).

FIG. 2 shows a block diagram of one embodiment of an application and of the edge cloud 1 according to FIG. 1 to a scenario with an agricultural business that also operates a power generation facility (e.g., with solar cells) on its land. An agricultural plant 5.1 and a local power generation unit 5.2 are located on the property 5 (e.g., of a farmer). Both the agricultural plant 5.1 and the power generation unit 5.2 possess an edge cloud 1, the computing power of which may be made available at least in part for a computing task 3 of a demander in accordance with the explanations provided in relation to FIG. 1. The power generation unit 5.2 has, for example, a solar plant 5.2.1, the power generated by which is delivered to a power consumer 4.

Further, the grid of the property 5 may be extended by wireless accesses that are not shown. The wireless access is connected to the locally implemented edge cloud 1, and the applications running in the respective virtual surroundings may communicate via this wireless access with apparatuses and grids connected thereto. Applications for which geographical proximity to apparatuses or sensors is necessary may thus then also be executed on the edge cloud IT of the property. One example is, for example, local use for applications from the agricultural realm. For example, this is useful for data-intensive tasks.

The described mechanism may be used in various operator models in this case: a) the described mechanism may be brought in by the owner or operator of the plant (e.g., by the farmer); or b) the plant operator rents its platform to a third party (e.g., a mobile communications operator or an agricultural cooperative).

The provision of computing power may be coupled to the present feed-in remuneration (e.g., if the power cannot be supplied to the superordinate grid economically, the plant may attempt to consume more energy locally in the form of computing power and thus offers more computing power at these times).

Although the invention has been illustrated and described more thoroughly in detail by the exemplary embodiments, the invention is not limited by the disclosed examples, and other variations may be derived therefrom by those skilled in the art without leaving the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An automated method for providing local computing capacity for at least one local computing unit for a less required computing task of a demander, wherein the at least one local computing unit is used at least in part for controlling a local power generation unit, wherein the at least one local computing unit is provided as part of a local edge cloud, and wherein electrical energy generated by the local power generation unit is used for supplying energy to the local edge cloud, the automated method comprising:
providing, by the local edge cloud, the local computing capacity to the demander only at times when excess electrical energy due to energy overproduction is available,
wherein exclusively the excess electrical energy is used for providing the local computing capacity.

2. The automated method of claim 1, further comprising determining, by a business policy manager module formed in the edge cloud, based on predefined rules, how much of and when the excess electrical energy is usable for executing the computing task.

3. The automated method of claim 2, wherein during the determining, the business policy manager module takes into account at least one external first parameter determined outside of the local power generation unit and at least one internal second parameter determined inside of the local power generation unit.

4. The automated method of claim 3, wherein the second parameter is an amount of energy currently being generated by the local power generation unit, an amount of energy to be delivered, or a combination thereof.

5. The automated method of claim 3, wherein the first parameter is present weather data, predictive weather data, data about planned works on the local power generation unit, market prices for the electrical energy, or any combination thereof.

6. The method of claim 2, wherein a strategy selector module formed in the local edge cloud parameterizes the business policy manager module and provides decision rules and decision priorities.

7. The method of claim 6, wherein user-specific roles are configured in the strategy selector module for parameterizing the business policy manager module.

8. The method of claim 7, wherein the user-specific role is an infrastructure owner, a customer, a trusted machine, or a trusted further edge cloud.

9. The method of claim 1, wherein the local edge cloud is logically interconnected with at least one further edge cloud dynamically depending on currently running applications.

10. A device for providing local computing capacity for at least one local computing unit for a less required computing task of a demander,
wherein the local computing unit is configured at least in part for controlling a local power generation unit,
wherein the local computing unit is configured as part of a local edge cloud,
wherein the device is configured to use electrical energy generated by the local power generation unit for supplying energy to the local edge cloud,
wherein the local edge cloud is configured to provide the local computing capacity to the demander only at times when excess electrical energy due to energy overproduction is available,
wherein exclusively the excess electrical energy is used for providing the local computing capacity.

11. The device of claim 10, comprising:
a business policy manager module formed in the local edge cloud and configured to determine, based on predefined rules, how much of and when the excess electrical energy is usable for executing the computing task.

12. The device of claim 11, wherein the business policy manager module is configured to take into account at least one external first parameter determined outside of the local power generation unit and at least one internal second parameter determined inside of the local power generation unit during the determination.

13. The device of claim 12, wherein:
the second parameter includes an amount of energy currently being generated by the local power generation unit, an amount of energy to be delivered, or a combination thereof;
the first parameter includes present weather data, predictive weather data, data about planned works on the local power generation unit, market prices for the electrical energy, or any combination thereof, or
a combination thereof.

14. The device of claim 11, further comprising:
a strategy selector module formed in the local edge cloud and configured to parameterize the business policy manager module and provide decision rules and decision priorities.

15. The device of claim 14, wherein user-specific roles are configured in the strategy selector module for parameterizing the business policy manager module.
